(19) United States
(12) Patent Application Publication
(10) Pub. No.: US 2018/0006823 A1
(43) Pub. Date: Jan. 4, 2018

(54) MULTI-HOP SECURE CONTENT ROUTING BASED ON CRYPTOGRAPHIC PARTIAL BLIND SIGNATURES AND EMBEDDED TERMS

(71) Applicant: QUALCOMM Incorporated, San Diego, CA (US)

(72) Inventors: Darrell Carbajal, San Diego, CA (US); Mihajlo Tomic, San Diego, CA (US); Jeffree Froelicher, San Diego, CA (US)

(21) Appl. No.: 15/200,870

(22) Filed: Jul. 1, 2016

(51) Int. Cl. H04L 9/32; H04L 9/30; H04L 9/14

(52) U.S. Cl. CPC H04L 9/3247; H04L 9/14; H04L 9/30

(57) ABSTRACT

At a transmitter node, a commitment value C is obtained as a function of a message m. The commitment value C and transmitter terms of use T^{A} for the message m are then sent to a receiver node without disclosing the message m. A cryptographic receiver signature S_{B} over the commitment value C and the transmitter terms of use T^{A} is received from the receiver node, where the cryptographic receiver signature S_{B} is signed with a private key kprv-B associated with the receiver node. The receiver signature S_{B} may be authenticated using a public key kpuh-B for the receiver node. If the receiver signature S_{B} is successfully authenticated, the message m and the receiver signature S_{B} are signed using a private key kprv-A for the transmitter node to obtain a transmitter signature S_{A}. The message m and the transmitter signature S_{A} may then be sent to the receiver node.

### BACKGROUND

### Field

One or more features relate to content routing across multiple nodes, and more particular to a way to have nodes agree to terms of use for the content prior to receiving the content and for a way to audit each node to ascertain that the terms of use for the content are being observed at each audited node.

### Background

When sharing information between nodes and across multiple hops, a system is needed to specify the terms of use and/or routing restrictions for sharing the information/content as it is transferred among the nodes. Prior to disclosing the information/content, the intended recipient (receiver) of the information/content should agree to the terms presented by the sender or provide counter-terms to which the sender must agree prior to disclosure of the information or content. Therefore, a method is needed to permit pairs of nodes along a chain of nodes to negotiate terms of use for a message (information or content) without disclosing the message to a receiving node until terms are fully negotiated.

### SUMMARY

A method, operational at a transmitter node (first node), is provided for distributing a message. At the transmitter node, a commitment value C is obtained (e.g., generated, derived, etc.) as a function of a message m. According to some examples, the message m may include digital video and/or audio content. The commitment value C and transmitter (sender) terms of use T^{A} for the message to are then sent to a receiver node (second node) without disclosing the message m. In response, a cryptographic receiver signature S_{B} over the commitment value C and the transmitter terms of use T^{A} is received from the receiver node, where the cryptographic receiver signature S_{B} is signed with a private key kprv-B associated with the receiver node. The receiver signature S_{B} may be authenticated using a public key kpub-B for the receiver node. If the receiver signature S_{B} is successfully authenticated, the message m and the receiver signature S_{B} may be signed using a private key kprv-A for the transmitter node to obtain a transmitter (sender) signature S_{A}. The message m and the transmitter signature S_{A} may then be sent to the receiver node.

According to one aspect, proposed receiver terms of use T^{B} may be received at the transmitter node from the receiver node. The transmitter node may then ascertain if the proposed (new) receiver terms of use T^{B} are acceptable to the transmitter node. The transmitter node sends the message m and transmitter signature S_{A} to the receiver node only the proposed receiver terms of use T^{B} are acceptable. The receiver signature S_{B} is also over the proposed receiver terms of use T^{B}. In one example, the receiver signature S_{B} may also be over the proposed receiver terms of use T^{B}.

According to various examples, the transmitter (sender) terms of use T^{A} may specify (a) an intended destination node for the message m, and/or (b) restrictions on distribution for the message m. The restrictions on distribution for the message m may include at least one of: (1) an expiration date for distribution and/or redistribution of the message m, (2) an expiration date for use of the message m, (3) a restriction on geographical distribution of the message m, and/or (4) a restriction on a number of times the message m is redistributed.

In other examples, the transmitter terms of use T^{A} may specify: (a) required terms of use that cannot be declined or change, by the receiver node, and/or (b) preferred terms of use that can be changed by proposed receiver terms of use by the receiver node.

According to yet another aspect, the method may include obtaining a random number r, wherein the commitment value C is also a function of the random number r. The transmitter signature S_{A} may also obtained by signing the random number r. The random number r is also sent to the receiver node.

In yet another example, an entropy value k is obtained, wherein the commitment value C is also a function of the entropy value k. The entropy value k may also be sent to the receiver node.

According to another feature a transmitter node is provided including a communication interface to communicate with other nodes, and/or a processing circuit coupled to the communication interface. The processing circuit configured to: (a) obtain, at the transmitter node, a commitment value C as a function of a message m; (b) send the commitment value C and transmitter (sender) terms of use T^{A} for the message m to a receiver node without disclosing the message m; (c) receive, from the receiver node, a cryptographic receiver signature S_{B} over the commitment value C and the transmitter terms of use T^{A}, signed with a private key kprv-B associated with the receiver node; (d) authenticate the receiver signature S_{B} using a public key kpub-B for the receiver node; (e) sign the message m and the receiver signature S_{B} using a private key kprv-A for the transmitter node to obtain a transmitter signature S_{A}; and/or (f) send the message m and the transmitter signature S_{A} to the receiver node.

In one example, the processing circuit may be further configured to obtain a random number r, wherein the commitment value C is also a function of the random number r. The transmitter signature S_{A} may also obtained by signing the random number r, and the processing circuit may be further configured to send the random number r to the receiver node after authenticating the receiver signature S_{B}.

Another feature provides a method operational at a receiver node. A commitment value C may be received, from a transmitter node, that is a function H of a message m without obtaining the message m. Transmitter terms of use T^{A} for the message m may also be received from the transmitter node.

The receiver node may then ascertain whether the transmitter terms of use T^{A} are acceptable to the receiver node. If so, the receiver node may sign the transmitter terms of use T^{A} and the commitment value C using a private key kprv-B for the receiver node to obtain a receiver signature S_{B}. The receiver signature S_{B} may then be sent to the transmitter node. In response, the receiver node may receive the message m and a transmitter signature S_{A} from the transmitter node, where the transmitter signature S_{A} is applied over the message m and the receiver signature S_{B} using a private key kprv-A for the transmitter node.

The receiver node may authenticate the transmitter signature S_{A} using a public key kpub-A for the transmitter node. The receiver node only obtains and sends the receiver signature S_{B} if the transmitter terms of use T^{A} are acceptable to it.

In another example, the receiver node may (a) obtain receiver terms of use T^{B}, and wherein the receiver signature S_{B} is also over the receiver terms of use T^{B}; and (b) send the receiver terms of use T^{B} to the transmitter node.

The transmitter terms of use T^{A} may specify: (a) an intended destination node for the message m, and/or (b) restrictions on distribution for the message m. The restrictions on distribution for the message m may include at least one of: (a) an expiration date for distribution and/or redistribution of the message m, (b) an expiration date for use of the message m, (c) a restriction on geographical distribution of the message m, and/or (d) a restriction on a number of times the message m is redistributed.

In another example, the transmitter terms of use T^{A} may specify: (a) required terms of use that cannot be declined or change by the receiver node, and/or (b) preferred terms of use that can be changed by proposed terms of use by the receiver node.

The commitment value C may also be a function of a random number r and the random number r is received after the receiver signature S_{B} is sent. The message m may be propagated from the receiver node to a third node with the transmitter terms of use T^{A}, proposed receiver terms of use T^{B} from the receiver node, the transmitter signature S_{A}, and the receiver signature S_{B}.

Yet another feature provides a receiver node, comprising: a communication interface to communicate with other nodes, and/or a processing circuit coupled to the communication interface. The processing circuit configured to: (a) receive, from a transmitter node, a commitment value C that is a function H of a message m without obtaining the message m; (b) receive, from the transmitter node, transmitter terms of use T^{A} for the message m; (c) ascertain whether the transmitter terms of use T^{A} are acceptable to the receiver node; (d) sign the transmitter terms of use T^{A} and the commitment value C using a private key kprv-B for the receiver node to obtain a receiver signature S_{B}; (e) send the receiver signature S_{B} to the transmitter node; and/or (f) receive the message m and a transmitter signature S_{A} from the transmitter node, where the transmitter signature S_{A} is applied over the message m and the receiver signature S_{B} using a private key kprv-A for the transmitter node.

### BRIEF DESCRIPTION OF THE DRAWINGS

FIG. 1 is a block diagram of an exemplary sharing of content/information from first node to a second node using partial blind signatures along with terms of use for that content/information.

FIG. 2 is a block diagram of an exemplary sharing of the content/information from the second node (of FIG. 1) to a third node (e.g., intermediate nodes) using partial blind signatures along with terms of use for that content/information.

FIG. 3 is a block diagram of an exemplary sharing of the content/information from the third node (of FIG. 2) to a destination fourth node using partial blind signatures along with terms of use for that content/information.

FIG. 4 illustrates an example of the information known to each node in FIGS. 1-3 after a successful transaction.

FIG. 5 is a block diagram illustrating an exemplary node device configured to share content (e.g. message) bound by partial blind signatures and terms of use.

FIG. 6 illustrates an exemplary method operational at a transmitter node (sender node or first node) for distributing a message m.

FIG. 7 illustrates an exemplary method operational at a receiver node (e.g., recipient node or second node) for distributing a message m.

### DETAILED DESCRIPTION

In the following description, specific details are given to provide a thorough understanding of the described implementations. However, it will be understood by one of ordinary skill in the art that the implementations may be practiced without these specific details. For example, circuits may be shown in block diagrams in order not to obscure the implementations in unnecessary detail. In other instances, well-known circuits, structures and techniques may be shown in detail in order not to obscure the implementations.

The word “exemplary” is used herein to mean “serving as an example, instance, or illustration.” Any implementation or embodiment described herein as “exemplary” is not necessarily to be construed as preferred or advantageous over other embodiments. Likewise, the term “embodiments” does not require that all embodiments include the discussed feature, advantage or mode of operation. The terms “node”, as used herein, is meant to he interpreted broadly. For example, a “node” may refer to a device that in communication with another node (e.g., via a point-to-point link or a network). In various instances, such “node” may be a mobile phone, pager, wireless modem, personal digital assistant, personal information manager (PIM), palmtop computer, laptop computer, network router, network server, access point node, digital tablet, and/or other mobile communication/computing device.

### Exemplary Partial Blind Signatures and Terms of Use for Content Distributed Across A Plurality of Node

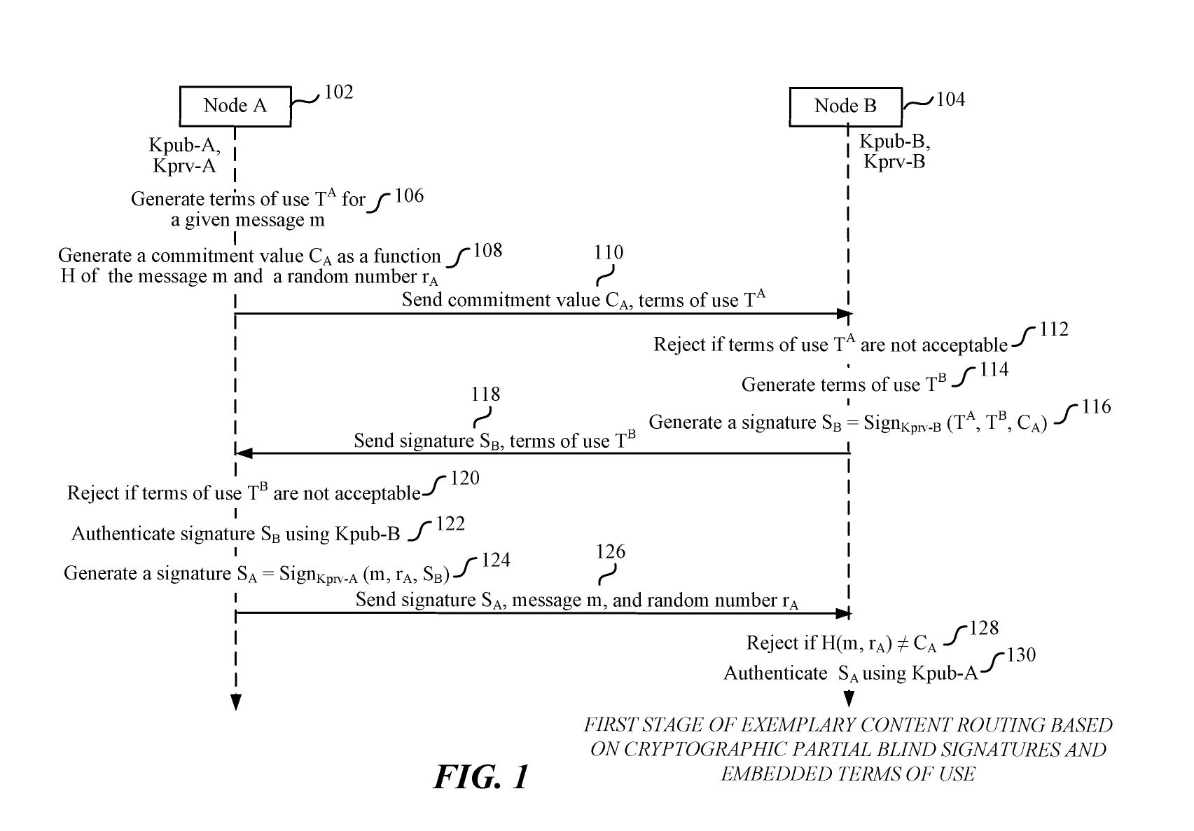

FIG. 1 is a block diagram of an exemplary sharing of content/information from a first node to a second node using partial blind signatures along with terms of use for that content/information. As used herein, “content” and/or “information” may be referred to as a “message”. A first node A 102 may have an associated cryptographic key pair, including a first private key Kprv-A and a corresponding first public key Kpub-A. In one example, the first private key Kprv-A may be kept secret (e.g., known only by the first node A) to encrypt/encode information. Meanwhile, the first public key Kpub-A may be freely/insecurely distributed to others to permit authentication/decrypt/decode anything signed with the first public key Kpub-A. Similarly, a second node B 104 may have an associated cryptographic key pair, including a second private key Kprv-B and a corresponding second public key Kpub-B.

In one example, the first node A 102 wishes to send a message m to the second node B 104 without revealing the message m until the second node B 104 has agreed to first terms of use T^{A} (e.g., terms of use provided by the first node A 102). The first node A 102 may generate or obtain the first terms of use T^{A} for the given message m 106. Terms of use may define, for example, an intended destination (e.g., intended target or destination node), an expiration time/date for distribution (e.g., message cannot/should not be distributed after expiration date), a restriction of a zone/region/country for distribution (e.g., distribution restricted to United States, etc.), and/or a maximum number of redistribution hops for the message, among other restrictions. In some implementations, the terms us of use may also include metadata for the message m, such as a message size, a message type (e.g., JPEG, audio, video, etc.), message description (e.g., a file name, a hash of a file name, etc.), a message hash digest (e.g., hash over the whole message m), a message classification level (e.g., security level, company proprietary level x, top secret, etc.). Subsequently, a receiving node (e.g. second node B 104) is able to verify some of these claimed terms after the message m is disclosed (e.g., size, type, hash), whereas other terms (e.g., message classification level, etc.) may not be automatically verifiable, by a receiving node but may be verifiable via an audit process. Examples of restrictions may include the restrictions on types of receiving nodes that are able or allowed to handle the message m (e.g., company/group/organization restriction, domain name restriction, trust level restriction, node/device/machine type/model restriction). In one example, node type information may be embedded in public key certificates, attested to by certificate authorities

The first node A 102 may generate a first commitment value C_{A} as a function H (e.g., a hash) of the message m and, for instance, a first random number r_{A} 108 (e.g., an n-bit number, a pseudorandom number, etc.). In one example, the first random number T_{A} may be generated at the first node A 102. In alternative implementations, the first random number r_{A} may he replaced by (e.g., or augmented with), for instance, a node identifier in combination with a time/date stamp, etc. Note that the “random number” is may also be referred to as a “private input” or a “commitment key” which is the value used to commit to a message but which is eventually revealed to a validating node/party. In another example, the random number r may be replaced and/or augmented by an entropy value k, which may be based on a date stamp, time stamp, a hash of the message, or other source of entropy.

The first commitment value C_{A} and the first terms of use T^{A} are then sent 110 to the second node B 104.

If the first terms of use T^{A} are unacceptable to the second node B 104, it may reject them 112. For instance, the second node B 104 may simply terminate the transaction with the first node A 102, or alternatively may include a contrary or proposed terms of its own. For instance, the second node B 104 may generate second terms of use T^{B} 114 in which it may define one or more terms of use for the message m. In some instances, the second terms of use T^{B} may propose terms that are in addition, but not contrary, to the first terms of use T^{A}. In other instances, the second terms of use T^{B} may propose one or more terms that are contrary to one or more of the first terms of use T^{A}. The second node B 104 may then generate a signature S_{B} by signing the first terms of use T^{A}, the second terms of use T^{B}, and the first commitment value C_{A} using its second private key Kprv-B 116. The signature S_{B} and the second terms of use T^{B} are then sent 118 to the first node A 102. Note that, in some implementations, the second node B 104 may simply use the first terms of use T^{A} and the signature S_{B} may be omitted or may be based on the first terms of use T^{A}. Subsequent nodes that receive the message m may or may not add their own terms of use, or may simply reuse the first terms of use T^{A}.

If the second terms of use T^{B} are unacceptable to the first node A 102, it may, reject them 120. Otherwise, the first node A 102 may authenticate the signature S_{B} by using the second public key Kpub-B 122. That is, the first node A 102 may apply the second public key Kpub-B to the signature S_{B} to verify that the first terms of use T^{A}, the second terms of use T^{B}, and the first commitment value C_{A} are the same as those known to the first node A. The first node A 102 may then generate its own signature S_{A} by signing the message m, first random number r_{A}, and the signature S_{B} using its first private key Kprv-A 124. The signature S_{A}, message m, and first random number r_{A} are then sent 126 to the second node B 104.

The second node B 104 verifies the received first commitment value C_{A} by obtaining a locally computed instance of the commitment value using the same function H and the received first random number r_{A}. If the received first commitment value C_{A} is different from the locally computed instance of the commitment value, then the second node B 104 may reject 12.8 the transaction (e.g., terminates transaction). Otherwise, the second node B 104 may authenticate the signature S_{A} using the first public key Kpub-A 130. If authentication is successful, the second node B 104 may store, retransmit, and/or use the message m as may be provided by the first terms of use T^{A} and/or the second terms of use T^{B}.

In this manner, the first node A's signature S_{A}, the second node B's signature S_{B}, the first terms of use T^{A}, the second terms of use T^{B}, and the first random number r_{A} serve as a contract for the message m between the first node A 102 and the second node B 104. The second node B 104 does not learn the message m until an agreement of terms has been reached.

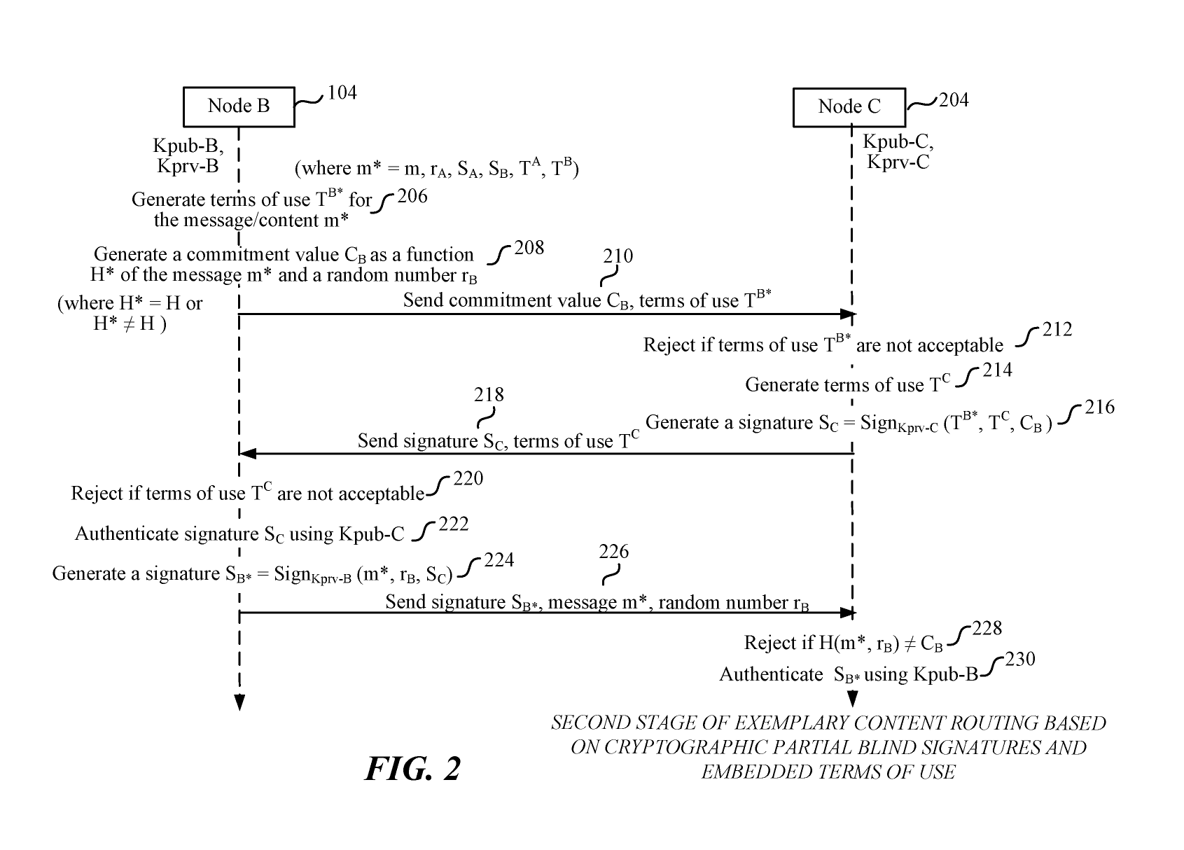

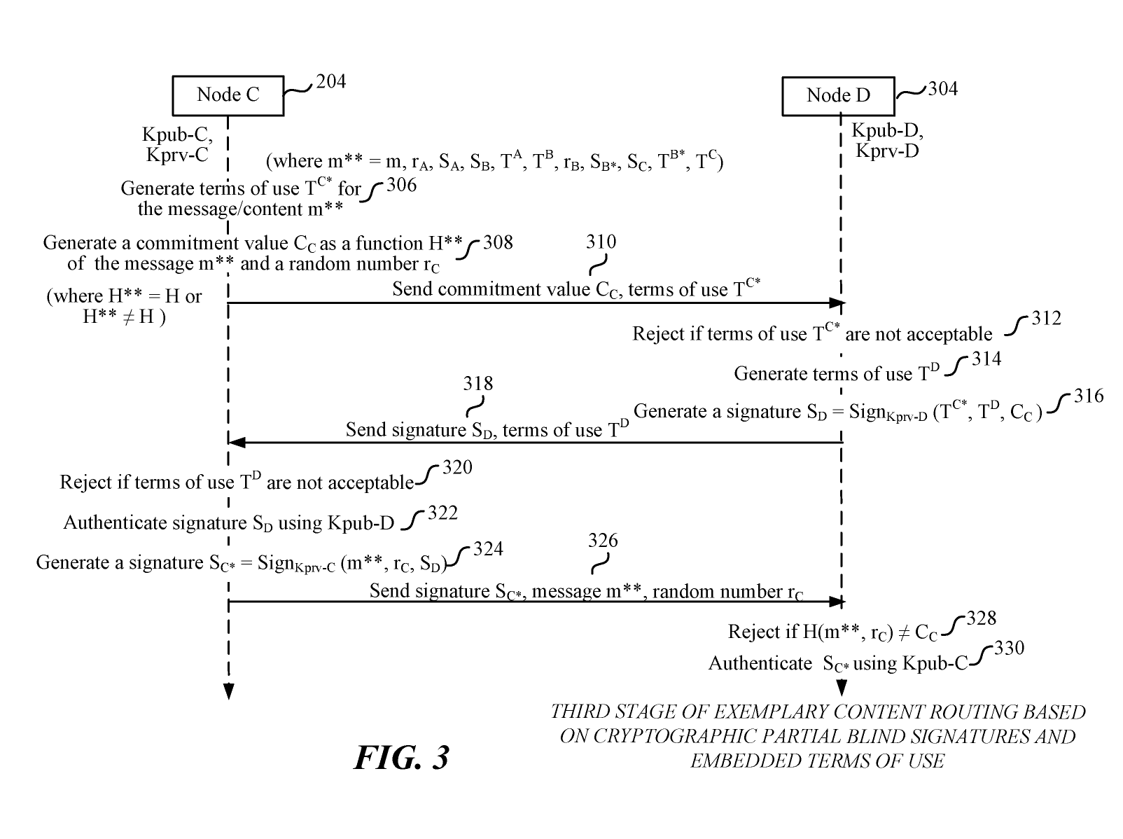

As illustrated in FIGS. 2 and 3, this same process may be repeated along multiple hops (e.g., among multiple different nodes A, B, C, D) until the message m reaches, for example, its intended destination (e.g., Node D). Alternatively, in a content-centric model, a message m (or data therein) may not ever have an intended endpoint or node. Rather, such message (or data therein) may be cached at various points/nodes along a network and is opportunistically transferred to a next node. For example, a node (e.g., a phone, user device, mobile device, etc.) may seek access to a movie or song (e.g., a multimedia file), but the movie or song happens to already be cached on a nearby network access point (e.g., a WiFi access point or a home PC). While the notion of a maximum number of hops in a content-centric: network may not yet exist, this scheme would allow for that.

Along each hop between nodes, the same cryptographic partial blind signature exchange (but with a distinct random number rₓ and using each node's public/private key pairs). In one example, the first terms of use T^{A} for the first node A may specify a destination node (e.g., node D) for the message m. Similarly, other terms of use along the way (T^{B}, T^{C}, T^{D}) may specify the destination node.

FIG. 2 is a block diagram of an exemplary sharing of the content/information from the second node (of FIG. 1) to a third node (e.g., intermediate nodes) using partial blind signatures along with terms of use for that content/information. The third node C 204 may have an associated cryptographic key pair, including a third private key Kprv-C and a corresponding third public key Kpub-C.

In one example, the second node B 104 may wish to forward the message m* to the third node C 204 without revealing the forwarded message m* until the third node C 204 has agreed to its terms of use T^{B*} (e.g., terms of use provided by the second node B). In various examples, the forwarded message m* may be the original message m, the first random number r_{A}, the first node A's signature S_{A}, the second node B's signature S_{B}, the first terms of use T^{A}, and/or the second terms of use T^{B}. In an alternative approach, the forwarded message m* may be the same as the original message m, while the first random number r_{A}, the first node A's signature S_{A}, the second node B's signature S_{B}, the first terms of use T^{A}, and/or the second terms of use T^{B} may be transmitted separately to the third node C 204.

The second node B 104 may generate or obtain second sender terms of use T^{B*} for the given message m* 206. The second sender terms of use T^{B*} may be the same as the second terms of use T^{B} or they may be different terms of use. The second node B 104 may generate a second commitment value C_{B} as a function H* (e.g., a hash) of the message m* and, for instance, a second random number r_{B} 208 (e.g., an n-bit number). The function H* may be the same or different from the function H used by the first node A 102. In one example, the second random number r_{B} may be generated at the second node B 104.

The second commitment value C_{B} and the second sender terms of use T^{B*} are then sent 210 to the third node C 204.

If the second sender terms of use T^{B*} are unacceptable to the third node C 204, it may reject them 212. Otherwise, the third node C 204 may generate third terms of use T^{C} 214 in which it may define one or more terms of use for the message m* (or it may propose contrary terms of use) to be forwarded. In some instances, the third terms of use T^{C} may propose terms that are in addition to, or even contrary, to the second sender terms of use T^{B*}. The third node C 204 may then generate a signature S_{C} by signing the second sender terms of use T^{B*}, the third terms of use T^{C}, and the second commitment value C_{B} using its third private key Kprv-C 216. The signature S_{C} and the third terms of use T^{C} are then sent 218 to the second node B 104.

If the third terms of use T^{C} are unacceptable to the second node B 104, it may reject them 220. Otherwise, the second node B 104 may authenticate the signature S_{C} by using the third public key Kpub-C 222. That is, the second node B 104 may apply the third public key Kpub-C to the signature Sc to verify that the second sender terms of use T^{B*}, the third terms of use T and the second commitment value C_{B} are the same as those known to the second node B. The second node B 104 may then generate its own signature S_{B*} by signing the message m*, second random number r_{B}, and the signature S_{C} using its second private key Kprv-B 224. The signature S_{B*}, message m*, and second random number r_{B} are then sent 226 to the third node C 204.

The third node C 204 verifies the received second commitment value C_{B} by obtaining a locally computed instance of the commitment value using the same function H* and the received second random number r_{B}. If the received second commitment value C_{B} is different from the locally computed instance of the commitment value, then the third node C 204 may reject 228 the transaction (e.g., terminates transaction). Otherwise, the third node C 204 may authenticate the signature S_{B*} using the second public key Kpub-B 230. If authentication is successful, the third node C 204 may store, retransmit, and/or use the message m* as may be provided by the first terms of use attached to the message m* (e.g., terms of use T^{A}, T^{B}, T^{B*}, and T^{C}).

FIG. 3 is a block diagram of an exemplary sharing of the content/information from the third node (of FIG. 2) to a destination fourth node using partial blind signatures along with terms of use for that content/information. The fourth node D 304 may have an associated cryptographic key pair, including a fourth private key Kprv-D and a corresponding fourth public key Kpub-D.

In one example, the third node C 204 may wish to forward the message m** to the fourth node D 304 without revealing the forwarded message m** until the fourth node D 304 has agreed to its terms of use T^{C*} (e.g., terms of use provided by the third node C). In various examples, the forwarded message m** may include the original message m, the first random number r_{A}, the first node A's signature S_{A}, the second node B's signature S_{B}, the first terms of use T^{A}, the second terms of use T^{B} the second random number r_{B}, the second node B's signature S_{B*}, the third node C's signature S_{C}, the second sender terms of use T^{B*}, and/or the third terms of use T^{C}. In an alternative approach, the forwarded message m** may he the same as the original message m, while the first random number r^{A}, the first node A's signature S_{A}, the second node B's signature S_{B}, the first terms of use T^{A}, the second terms of use T^{B}, the second random number r_{B}, the second node B's signature S_{B*}, the third node C's signature S_{C}, the second sender terms of use T^{B*}, and/or the third terms of use T^{C} may be transmitted separately to the fourth node D 304.

The third node C 204 may generate or obtain third sender terms of use T^{C*} for the given message m** 306. The third sender terms of use T^{C*} may be the same as the second terms of use T^{B} or they may be different terms of use. The third node C 204 may generate a third commitment value C_{C} as a function H** (e.g., a hash) of the message m** and, for instance, a third random number r_{C} 308 (e.g., an n-bit number). The function H** may he the same or different from the function H used by the first node A 102 or function H* used by the second node B 104. In one example, the third random number r_{C} may be generated at the third node C 204.

The third commitment value C_{C} and the third sender terms of use T^{C*} are then sent 310 to the fourth node D 304.

If the third sender terms of use T^{C*} are unacceptable to the fourth node D 304, it may reject them 312. Otherwise, the fourth node D 304 may generate fourth terms of use T^{D} 314 in which it may define one or more terms of use for the message m** (or it may propose contrary terms of use) to he forwarded. In some instances, the fourth terms of use T^{D} may propose terms that are in addition to, or even contrary, to the third sender terms of use T^{C*}. The fourth node D 304 may then generate a signature S_{D} by signing the third sender terms of use T^{C} , the fourth terms of use T^{D}, and the third commitment value C_{C} using its fourth private key Kprv-D 316. The signature S_{D} and the fourth terms of use T^{D} are then sent 318 to the third node C 204.

If the fourth terms of use T^{D} are unacceptable to the third node C 204, it may reject them 320. Otherwise, the third node C 204 may authenticate the signature S_{D} by using the fourth public key Kpub-D 322. That is, the third node C 204 may apply the fourth public key Kpub-D to the signature S_{D} to verify that the third sender terms of use T^{C*}, the fourth terms of use T^{D}, and the third commitment value C_{C} are the same as those known to the third node C. The third node C 204 may then generate its own signature S_{C*} by signing the message m**, the third random number r_{C}, and the signature S_{D} using its third private key Kprv-C 324. The signature S_{C*}, message m**, and third random number r_{C} are then sent 326 to the fourth node D 304.

The fourth node C 304 verifies the received third commitment value C_{C} by obtaining a locally computed instance of the commitment value using the same function H** and the received third random number r_{C}. If the received third commitment value C_{C} is different from the locally computed instance of the commitment value, then the fourth node D 304 may reject 328 the transaction (e.g., terminates transaction). Otherwise, the fourth node D 304 may authenticate the signature S_{C*} using the third public key Kpub-C 330. If authentication is successful, the fourth node D 304 may store and/or use the message m** as may be provided by the first terms of use attached to the message m* (e.g., terms of use T^{A}, T^{B}, T^{B*}, T^{C}TC*, T^{D}).

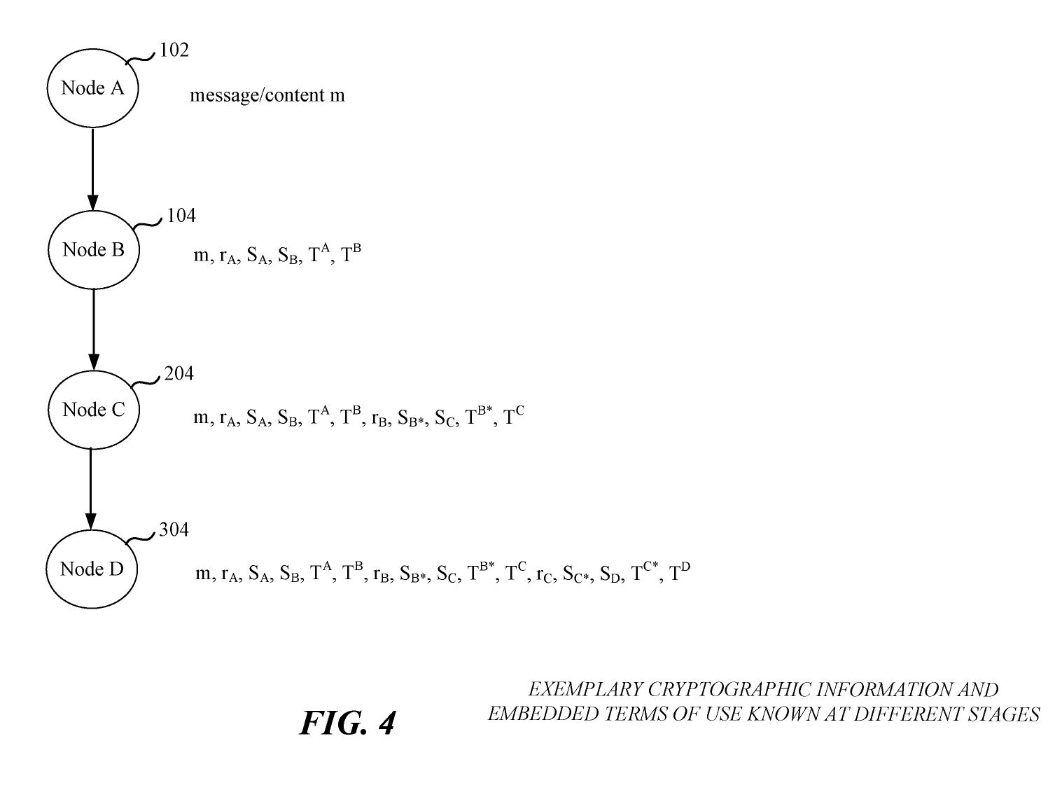

FIG. 4 illustrates an example of the information known to each node in FIGS. 1-3 after a successful transaction.

While the partial blind cryptographic signatures and terms of use do not prevent a rogue node from sending the message to other nodes, this approach does provide for auditing of each node to ascertain if the terms of use T^{A}, T^{B}, T^{C}, T^{D} for the message m are being observed. For instance, auditing of a node that is not supposed to have message m will reveal, e.g., from one or more of the terms, whether any terms have been violated along the path. More specifically, an auditing mechanism may permit ascertaining whether a particular node has altered commitment information for a message. For instance, the auditing mechanism may track meta-data for a particular message m (e.g., random number for each node, signature for each node, terms of use for each node, etc.) as it is transferred along a plurality of nodes. By collecting information for the same message m, an authenticating node is able to ascertain if a signature, or other information associated with the message has been changed or modified. The auditing node would not only be able to ascertain whether meta-data for the message m has been changed, but also whether the terms of use have been violated by a particular audited node.

Note that, the message m is transferred among nodes, some nodes may add terms of use that are contrary to earlier specified terms of use. In such instances, a protocol may indicate that an earlier added term of use (e.g., associated with an originating node) may take precedence over a later added term of use.

### Exemplary Node Device and Method(s) Operational Therein

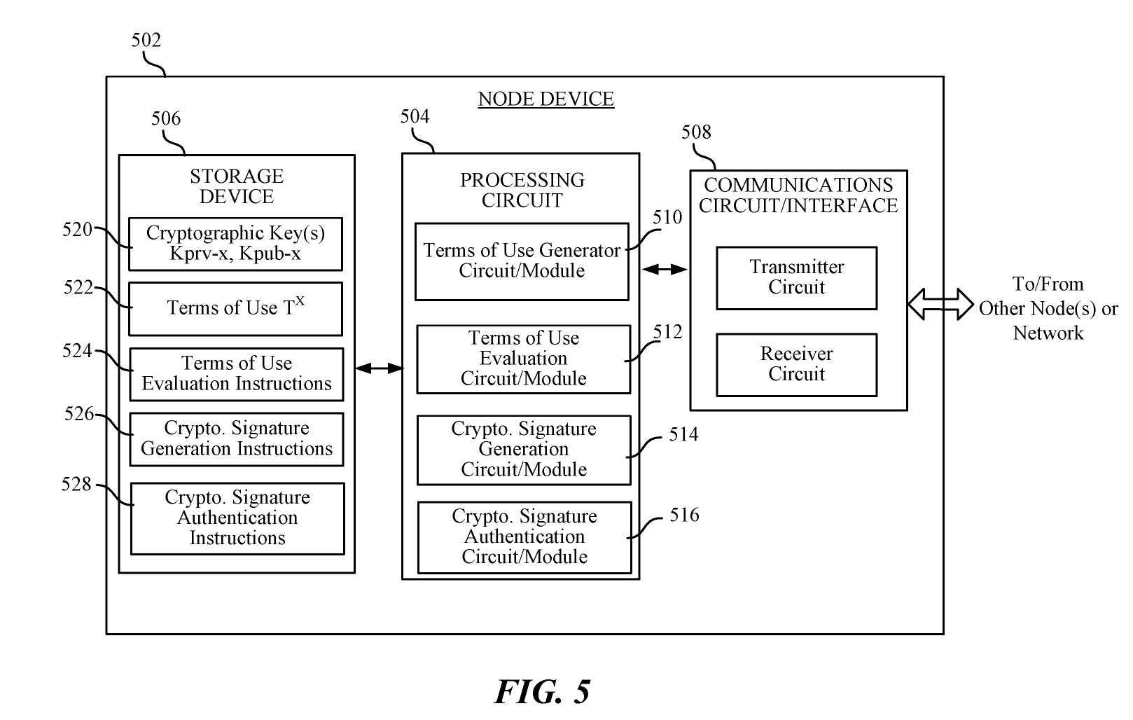

FIG. 5 is a block diagram illustrating an exemplary node device (e.g., transmitter or receiver node) configured to share content (e.g. message) bound by partial blind signatures and terms of use. The node device 502 may include a processing circuit 504 coupled to a storage device 506 and/or a communication circuit/interface 508. The communication Circuit interface 508 may include a transmitter circuit and/or receiver circuit to communicate with one or more other nodes and/or network(s). In various examples, the method for sharing content (e.g., message) may be implemented with subsystems (e.g., internal nodes) with a single device, or may be implemented in an overlay network (e.g., where the network nodes may reside on physically separate or distinct networks).

The processing circuit 504 may include various circuits and/or modules that perform one or more functions described herein. For instance, a terms of use generator circuit/module 510 may serve to generate terms of use for a message to be shared and/or propose terms of use for a message to be received. In various examples, the terms of use generator circuit/module 510 may combine one or more pre-stored terms of use (e.g., within the storage device) or may dynamically identify which terms of use to apply to a particular message, and/or may apply a predefined set of terms of use. A terms of use evaluation circuit/module 512 may allow the node device 502 to ascertain and/or decide whether terms of used received from another node (e.g., as part of a transaction) are acceptable or not. For instance, the node device 502 may include a list of one or more terms of use which are unacceptable and the terms of use evaluation circuit/module 512 may simply compares the received terms of use to the list of unacceptable terms of use. A cryptographic signature generation circuit/module 514 may serve to generate cryptographic signatures (e.g., using a private key from a private-public key pair for the node device 502). Similarly, a cryptographic signature authentication circuit/module 516 may serve to authenticate cryptographic signatures received from other node devices (e.g., using a public key for the sending node device).

In one example, the storage device 506 may include instructions to perform one or more functions of the node device. For instance, the storage device 506 may include a cryptographic key pair 520 (e.g., a private key Kprv-x and a corresponding public key Kpub-x) and/or pre-stored, dynamically-generated, and/or received terms of use T^{X} 522. Additionally, terms of use evaluation instructions 524 may be used or executed by the processing circuit 504 to evaluate received terms of use from another node (e.g., to ascertain whether to accept or reject the received terms of use).

The storage device 506 may also include, cryptographic signature generation instructions 526 that may be used or executed by the processing circuit 504 to generate cryptographic signatures as illustrated, for example, in FIGS. 1-4. Similarly, the storage device 506 may include, cryptographic signature authentication instructions 528 that may be used or executed by the processing circuit 504 to authenticate received cryptographic signatures as illustrated, for example, in FIGS. 1-4.

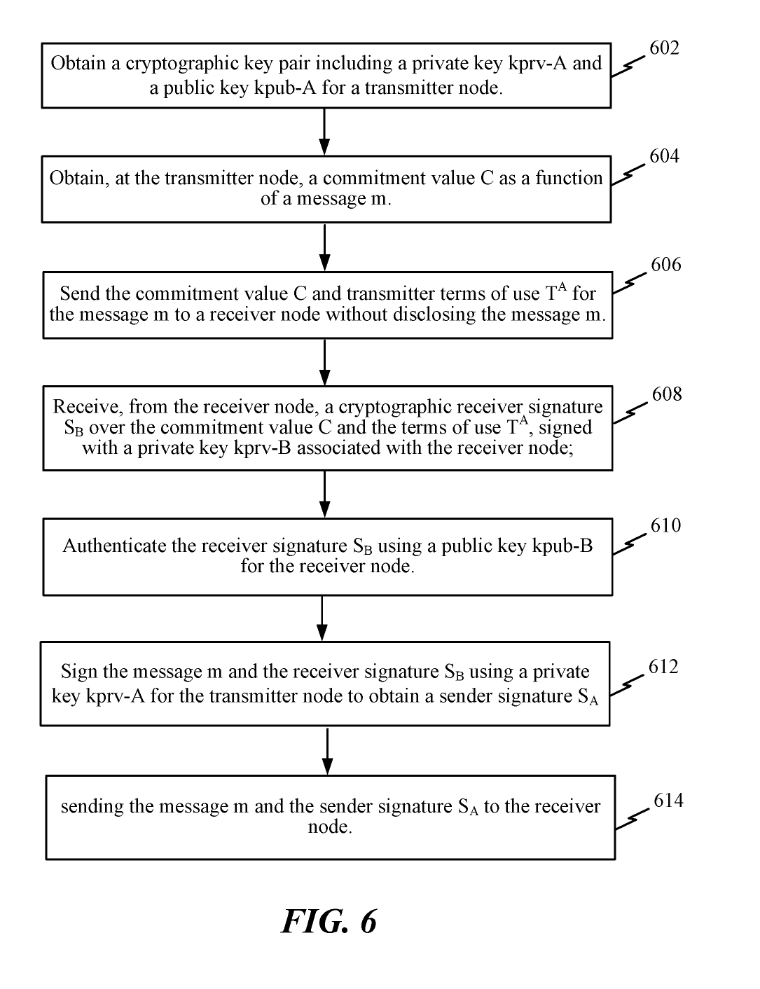

FIG. 6 illustrates an exemplary method operational at a transmitter node (e.g., sender node, first node) for distributing a message m. In one example, the transmitter node may be the node device 502 illustrated in FIG. 5. The transmitter node may obtain a cryptographic key pair including a private key kprv-A and a public key kpub-A for the transmitter node 602. A commitment value C may be obtained as a function of a message m 604. In one example, the message m may include digital video and/or audio content. The transmitter node may then send the commitment value C and terms of use T^{A} for the message m to a receiver node (e.g., recipient node or second node) without disclosing the message m 606.

Subsequently, the transmitter node may receive, from the receiver node, a cryptographic receiver signature S_{B} over the commitment value C and the terms of use T^{A}, signed with a private key kprv-B associated with the receiver node 608.

The transmitter node may then authenticate the receiver signature S_{B} using a public key kpub-B for the receiver node 612. The transmitter node may then obtain a transmitter signature S_{A} by signing the message m and the receiver signature S_{B} using a private key kprv-A for the transmitter node 612. The message m and the transmitter signature S_{A} may then be sent to the receiver node (e.g., second node or recipient node) 614.

Additionally, after sending the commitment value C, the transmitter node may receive proposed terms of use T^{B} from the receiver node. The transmitter node may then ascertain if the proposed (new) terms of use T^{B} are acceptable to the transmitter node, and wherein the transmitter node sends the message m and transmitter signature S_{A} to the receiver node only the proposed terms of use T^{B} are acceptable. The receiver signature S_{B} may also be over the proposed terms of use T^{B}. Additionally, the receiver signature S_{B} is also over the proposed terms of use T^{B}.

In one example, the terms of use T^{A} specify an intended destination node for the message m. In another example, the terms of use T^{A} specify restrictions on distribution for the message m. The restrictions on distribution for the message m may include at least one of: (a) an expiration date for distribution and/or redistribution of the message m, (h) an expiration date for use of the message m, (c) a restriction on geographical distribution of the message m, and/or (d) a restriction on a number of times the message m is redistributed.

In another example, terms of use T^{A} may specify: (a) required terms of use that cannot be declined or change by the receiver node, and (b) preferred terms of use that can be changed by proposed terms of use by the receiver node.

In another implementation, the transmitter node may obtain a random number r, wherein the commitment value C is also a function of the random number r. The transmitter signature S_{A} may also he obtained by signing the random number r. The random number r is sent to the receiver node after authenticating the receiver signature S_{B}.

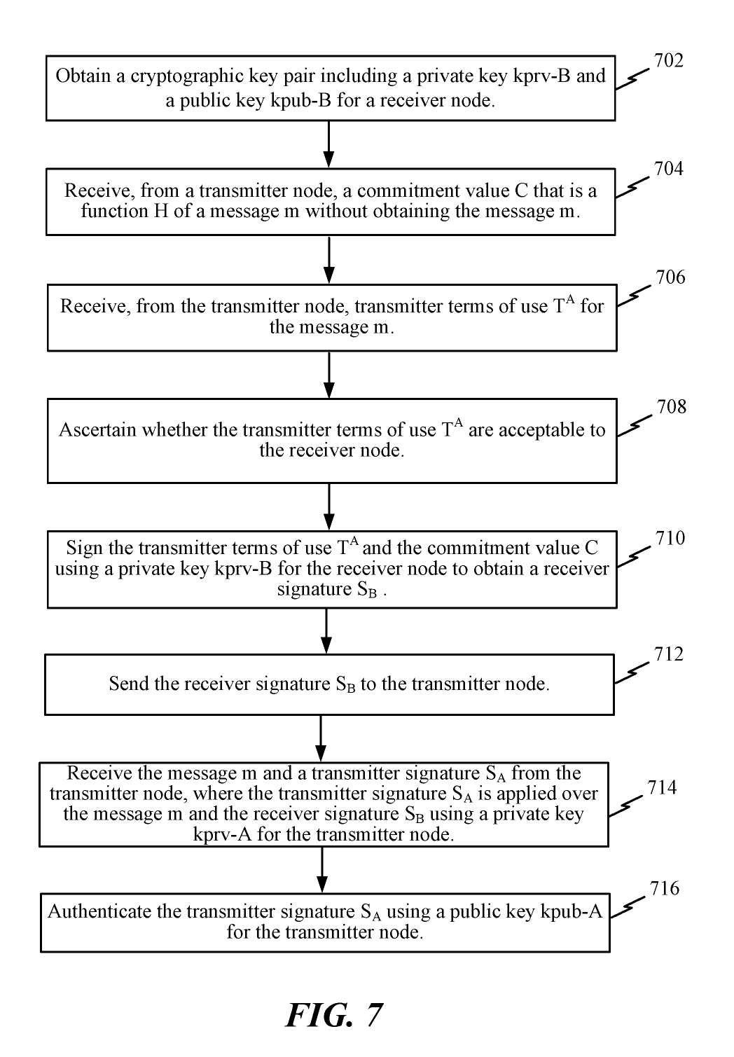

FIG. 7 illustrates an exemplary method operational at a receiver node (e.g., recipient node or second node) for distributing a message m. In one example, the receiver node may be the node device 502 illustrated in FIG. 5. The receiver node may obtain a cryptographic key pair including a private key kprv-B and a public key kpub-B for the receiver node 702. The receiver node may receive, from a transmitter node, a commitment value C that is a fraction H of a message m without obtaining the message m 704.

In response, the receiver node may receive, from the transmitter node, transmitter terms of use T^{A} for the message m (without receiving the message m) 706. The receiver node may then ascertain whether the transmitter terms of use T^{A} are acceptable to the receiver node 708.

If the transmitter terms of use T^{A} are acceptable, the receiver node may sign the transmitter terms of use T^{A} and the commitment value C using a private key kprv-B for the receiver node to obtain a receiver signature S_{B} 710. The receiver signature S_{B} is then sent to the transmitter node 712. In response, the receiver node may receive the message m and a transmitter signature S_{A} from the transmitter node, where the transmitter signature S_{A} is applied over the message m and the receiver signature S_{B} using a private key kprv-A for the transmitter node 714.

The receiver node may then authenticate the transmitter signature S_{A} using a public key kpub-A for the transmitter node 716.

Note that the receiver node only obtains and sends the receiver signature S_{B} if the transmitter terms of use T^{A} are acceptable to it.

However, if the transmitter terms of use T^{A} are not acceptable or if the receiver node wishes to propose its own terms of use, the receiver node may obtain receiver terms of use T^{B}, and the receiver signature S_{B} is also over the receiver terms of use T^{B}. The receiver node then sends the receiver terms of use T^{B} to the transmitter node.

In one example, the transmitter terns of use T^{A} may specify an intended destination node for the message m. In another example, the transmitter terms of use T^{A} may specify restrictions on distribution for the message m. For instance, the restrictions on distribution for the message m may include at least one of: (a) an expiration date for distribution and/or redistribution of the message m, (b) an expiration date for use of the message m, (c) a restriction on geographical distribution of the message m, and/or (d) a restriction on a number of times the message m is redistributed.

In one example, the transmitter terms of use T^{A} specify: (a) required terms of use that cannot be declined or change by the receiver node, and (b) preferred terms of use that can be changed by proposed terms of use by the receiver node.

The commitment value C is also a function of a random number r and the random number r is received after the receiver signature S_{B} is sent.

The message m may be propagated from the receiver node to a third node with the transmitter terms of use T^{A}, proposed terms of use T^{B} from the receiver node, the transmitter signature S_{A}, and the receiver signature S_{B}.

One or more of the components, steps, features and/or functions illustrated in FIGS. 1, 2, 3, 4, 5, 6, and/or 7 may be rearranged and/or combined into a single component, step, feature or function or embodied in several components, steps, or functions. Additional elements, components, steps, and/or functions may also be added without departing from the invention. The apparatus, devices, and/or components illustrated in FIGS. 1, 5, and/or 5 may be configured to perform one or more of the methods, features, or steps described in FIGS. 1, 2, 3, 4, 6, and/or 7. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently, in addition, the order of the operations may be re-arranged. A process is terminated when its operations are completed. A process may correspond to a method, a function, a procedure, a subroutine, a subprogram, etc. When a process corresponds to a fraction, its termination corresponds to a return of the function to the calling function or the main function.

Moreover, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The terms “machine-readable medium” “computer-readable medium”, and/or “processor-readable medium” may include, but are not limited to portable or fixed storage devices, optical storage devices, and various other non-transitory mediums capable of storing, containing or carrying instruction(s) and/or data. Thus, the various methods described herein may be partially or fully implemented by instructions and/or data that may be stored in a “machine-readable medium”, “computer-readable medium”, and/or “processor-readable medium” and executed by one or more processors, machines and/or devices.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method, operational at a transmitter node, for distributing a message, comprising:
obtaining, at the transmitter node, a commitment value C as a function of a message m;
sending the commitment value C and transmitter terms of use T^{A} for the message m to a receiver node without disclosing the message m;
receiving, from the receiver node, a cryptographic receiver signature S_{B} over the commitment value C and the transmitter terms of use T^{A}, signed with a private key kprv-B associated with the receiver node;
authenticating the receiver signature S_{B} using a public key kpub-B for the receiver node;
signing the message m and the receiver signature S_{B} using a private key kprv-A for the transmitter node to obtain a transmitter signature S_{A}; and
sending the message m and the transmitter signature S_{A} to the receiver node.

2. The method of claim 1, further comprising:
receiving, at the transmitter node, proposed receiver terms of use T^{B} from the receiver node.

3. The method of claim 2, further comprising:
ascertaining if the proposed receiver terms of use T^{B} are acceptable to the transmitter node, and wherein the transmitter node sends the message m and the transmitter signature S_{A} to the receiver node only the proposed receiver terms of use T^{B} are acceptable.

4. The method of claim 3, wherein the receiver signature S_{B} is also over the proposed receiver terms of use T^{B}.

5. The method of claim 2, wherein the receiver signature S_{B} is also over the proposed receiver terms of use T_{B}.

6. The method of claim 1, wherein the transmitter terms of use T^{A} specify an intended destination node for the message m.

7. The method of claim 1, wherein the transmitter terms of use T^{A} specify one or more restrictions on distribution for the message m.

8. The method of claim 7, wherein the restrictions on distribution for the message m include at least one of:
an expiration date for distribution and/or redistribution of the message m,
an expiration date for use of the message m,
a restriction on geographical distribution of the message m, and/or
a restriction on a number of times the message m is redistributed.

9. The method of claim 1, wherein the transmitter terms of use T^{A} specify at least one of:
(a) required terms of use that cannot be declined or change by the receiver node, and
(b) preferred terms of use that can he changed by proposed receiver terms of use by the receiver node.

10. The method of claim 1, wherein the message m includes digital video and/or audio content.

11. The method of claim 1, further comprising:
obtaining a random number r, wherein the commitment value C is also a function of the random number r, wherein the transmitter signature S_{A} is also obtained by signing the random number r; and
sending the random number r to the receiver node.

12. The method of claim 1, further comprising:
obtaining an entropy value k, wherein the commitment value C is also a function of the entropy value k.

13. A transmitter node, comprising:
a communication interface to communicate with other nodes;
a processing circuit coupled to the communication interface, the processing circuit configured to
obtain, at the transmitter node, a commitment value C as a function of a message m;
send the commitment value C and transmitter terms of use T^{A} for the message m to a receiver node without disclosing the message m;
receive, from the receiver node, a cryptographic receiver signature S_{B} over the commitment value C and the transmitter terms of use T^{A}, signed with a private key kprv-B associated with the receiver node;
authenticate the receiver signature S_{B} using a public key kpub-B for the receiver node;
sign the message m and the receiver signature S_{B} using a private key kprv-A. for the transmitter node to obtain a transmitter signature S_{A}; and
send the message m and the transmitter signature S_{A} to the receiver node,

14. The transmitter node of claim 13, wherein the processing circuit is further configured to:
obtain a random number r, wherein the commitment value C is also a function of the random number r.

15. The transmitter node of claim 14, wherein the transmitter signature S_{A} is also obtained by signing the random number r, and the processing circuit is further configured to:
send the random number r to the receiver node after authenticating the receiver signature S_{B}.

16. The transmitter node of claim 13, wherein the transmitter terms of use T^{A} specify restrictions on distribution for the message m.

17. The transmitter node of claim 13, wherein the transmitter terms of use T^{A} specify at least one of:
(a) required terms of use that cannot he declined or change by the receiver node, and
(b) preferred terms of use that can be changed by proposed terms of use by the receiver node.

18. A method operational at a receiver node, comprising:
receiving, from a transmitter node, a commitment value C that is a function H of a message m without obtaining the message m;
receiving, from the transmitter node, transmitter terms of use T^{A} for the message m;
ascertaining whether the transmitter terms of use T^{A} are acceptable to the receiver node;
signing the transmitter terms of use T^{A} and the commitment value C using a private key kprv-B for the receiver node to obtain a receiver signature S_{B};
sending the receiver signature S_{B} to the transmitter node; and
receiving the message m and a transmitter signature S_{A} from the transmitter node, where the transmitter signature S_{A} is applied over the message m and the receiver signature S_{B} using a private key kprv-A for the transmitter node.

19. The method of claim 18, further comprising:
authenticating the transmitter signature S_{A} using a public key kpub-A for the transmitter node.

20. The method of claim 18, wherein the receiver node only obtains and sends the receiver signature S_{B} if the transmitter terms of use T^{A} are acceptable to it.

21. The method of claim 18, further comprising:
obtaining receiver terms of use T^{B}, and wherein the receiver signature S_{B} is also over the receiver terms of use T^{B}; and
sending the receiver terms of use T^{B} to the transmitter node.

22. The method of claim 18, wherein the transmitter terms of use T^{A} specify an intended destination node for the message m.

23. The method of claim 18, wherein the transmitter terms of use T^{A} specify restrictions on distribution for the message m.

24. The method of claim 23, wherein the restrictions on distribution for the message in include at least one of:
an expiration date for distribution and/or redistribution of the message m,
an expiration date for use of the message m,
a restriction on geographical distribution of the message m, and/or
a restriction on a number of times the message m is redistributed.

25. The method of claim 18, wherein the transmitter terms of use specify at least one of
(a) required terms of use that cannot be declined or change by the receiver node, and
(b) preferred terms of use that can be changed by proposed receiver terms of use by the receiver node.

26. The method of claim 18, wherein the commitment value C is also a function of a random number r and the random number r is received after the receiver signature S_{B} is sent.

27. The method of claim 18, wherein the message m is propagated from the receiver node to a third node with the transmitter terms of use T^{A}, proposed receiver terms of use T^{B} from the receiver node, the transmitter signature S_{A}, and the receiver signature S_{B}.

28. The method of claim 18, wherein the commitment value C is also a function of an entropy value k and the entropy value k is received after the receiver signature S_{B} is sent.

29. A receiver node, comprising:
a communication interface to communicate with other nodes;
a processing circuit coupled to the communication interface, the processing circuit configured to
receive, from a transmitter node, a commitment value C that is a function H of a message m without obtaining the message m;
receive, from the transmitter node, transmitter terms of use T^{A} for the message m;
ascertain whether the transmitter terms of use T^{A} are acceptable to the receiver node;
sign the transmitter terms of use T^{A} and the commitment value C using a private key kprv-B for the receiver node to obtain a receiver signature S_{B};
send the receiver signature S_{B} to the transmitter node; and
receive the message m and a transmitter signature S_{A} from the transmitter node, where the transmitter signature S_{A} is applied over the message m and the receiver signature S_{B} using a private key kprv-A for the transmitter node.

30. The receiver node of claim 29, wherein the commitment value C is also a function of a random number r and the random number r is received after the receiver signature S_{B} is sent.
